(19) United States
(12) Patent Application Publication
(10) Pub. No.: US 2025/0252721 A1
(43) Pub. Date: Aug. 7, 2025

(54) METHOD AND SYSTEM FOR RESTORING A COMPRESSED IMAGE WITH RAINDROPS

(71) Applicant: City University of Hong Kong, Kowloon (HK)

(72) Inventors: Sam Tak Wu KWONG, Kowloon (HK); Rongqun LIN, Kowloon (HK); Shiqi WANG, Kowloon (HK)

(21) Appl. No.: 18/433,836

(22) Filed: Feb. 6, 2024

(51) Int. Cl. G06V 10/80; G06T 3/067; G06T 5/20; G06V 10/44

(52) U.S. Cl. CPC G06V 10/806; G06T 3/067; G06T 5/20; G06V 10/44

(57) ABSTRACT

A computer-implemented method for restoring a compressed image with raindrops includes applying dual branches in a complementary manner for capturing low-frequency features and high-frequency features from the compressed image, extracting the high-frequency features by a high-frequency depth-wise convolution (HFDC) with zero-mean kernels, and fusing the low-frequency features and the high-frequency features by a low-high-attention module (LHAM) by adaptively allocating the importance of the branches among channels.

### TECHNICAL FIELD

The present invention relates to methods and systems for restoring a compressed image with raindrops.

### BACKGROUND

Raindrops covering a glass window or camera lens degrade the image visibility and severely hamper many downstream computer vision tasks, such as video surveillance and autonomous driving. Specifically, raindrops widely blur the camera's focus and introduce different imageries from non-raindrop regions. Consequently, removing raindrops from images has become an essential task and attracted much research interest. It is challenging since restoring large areas obscured by raindrops requires sufficient priors, especially global contextual information. Recently, many efforts [1]-[9] have been devoted to raindrop removal, including the convolutional neural network (CNN) based methods [1]-[8] and the transformer-based method [9]. Some CNN-based methods are dedicated to leveraging more raindrop priors, such as mask-guided [2]-[5] and edge-shape-guided [6]methods. Other works aim to improve the capability of CNN by introducing elegant modules and structures like dual residual block (DuRB) [7] and laplacian-pyramid encoder-decoder [8]. Nevertheless, the intrinsic limitation of CNN for modeling global contextual information still exists due to the fixed kernels and local operations. Recently, a transformer-based deraining method [9] has shown improved performance compared to CNN-based methods due to its powerful non-local modeling ability. However, most of the existing raindrop removal methods are designed for uncompressed or slightly compressed images, which cannot perform well on normally or strongly compressed images with raindrops in a realistic scenario.

Images are inevitably compressed in real applications to reduce the storage overhead and improve transmission efficiency. Nowadays, conventional block-based image compression methods like JPEG [10], JPEG 2000 [11], and BPG [12], are widely deployed coding infrastructures, which apply handcrafted transform, quantization, and entropy coding to reduce spatial and statistical redundancies from images. The transform technique in image compression aims to transform the image from the spatial domain to the frequency domain, resulting in compact and decorrelated coefficients. Then, the quantization is adopted to remove less important redundant information for lossy compression. Typically, the high-frequency components in the transformed coefficients are consistently quantized to zero to achieve greater compression efficiency. The significant loss of high-frequency information results in texture loss and blurry outputs. Moreover, the blocking artifacts are introduced by the block-based transform and quantization, which leads to the discontinuities of neighboring blocks.

When the visual degradation resulting from both raindrop interference and compression becomes intertwined, the introduced hybrid distortion becomes much more complex. Raindrops obscure background textures, and in non-raindrop regions, high-frequency details are lost due to compression, as illustrated in FIG. 1. FIG. 1 shows examples of ground truth images (the first column), raindrop images (the second column), and compressed raindrop images (the third column). Compressed raindrop images contain more complex degradation, including raindrop-obscured backgrounds and high-frequency detail loss in non-raindrop regions due to compression. More importantly, the rain-related context is corrupted by the block-based coding paradigm. These coding blocks partition the raindrops, causing raindrops to take irregular shapes and breaking up the context, which results in deviated raindrop distributions. Therefore, these intertwined factors make rain removal from images more challenging.

### SUMMARY OF THE INVENTION

In addressing the aforementioned challenging obstacles, some embodiments of the invention endeavour to offer an integrated solution. The main idea is to build an effective framework that captures local and global information to facilitate accurate contextual modeling. Besides, the high-frequency information is paid special attention in module design for high-frequency textural detail recovery. In detail, provided is a novel transformer-based model, which achieves efficient global context modeling with a self-attention mechanism and promotes the restoration of high-frequency information by introducing the high-frequency-friendly design at framework, component, and module levels.

According to a first aspect of the invention, there is provided a computer-implemented method for restoring a compressed image with raindrops, which includes applying dual branches in a complementary manner for capturing low-frequency features and high-frequency features from the compressed image, extracting the high-frequency features by a high-frequency depth-wise convolution (HFDC) with zero-mean kernels, and fusing the low-frequency features and the high-frequency features by a low-high-attention module (LHAM) by adaptively allocating the importance of the branches among channels.

In some embodiments, the low-frequency features may include global contextual information under raindrops, and the high-frequency features may include local high-frequency details which can be lost due to compression.

In some embodiments, the dual branches may include a low-frequency branch to extract the low-frequency features by a self-attention mechanism, and a high-frequency branch to extract the high-frequency features by the HFDC.

In some embodiments, the self-attention mechanism may include a relative position multi-head self-attention (RMSA).

In some embodiments, extracting the high-frequency features by the HFDC may include splitting an input of the HFDC into multiple channels, applying a high-frequency convolution (HFConv) on each channel, and concatenating features from each channel.

In some embodiments, applying the HFConv on each channel may include removing a spatial mean from initial kernels and applying the resulted kernels on convolution.

In some embodiments, the high-frequency branch may include a reshaping/flattening operation, the HFDC, and a 1×1 point-wise convolution (PConv).

In some embodiments, the LHAM may be a window-wise attention scheme, which is performed in each local window.

In some embodiments, the process in the local window may include mixing the low-frequency features and the high-frequency features from the two branches to obtain integrated features, and reshaping the integrated features into spatial features which are further fed to a ReLU layer to obtain mixed features, aggregating the mixed features to obtain compact features by applying average pooling on each channel, obtaining weight matrices for the low-frequency features and the high-frequency features from the compact features, and generating weighted low-frequency and high-frequency features by performing a channel-wise addition on the low-frequency and the high-frequency features and their corresponding weight matrices, and generating fused features by performing an element-wise addition.

In some embodiments, in generating the fused features, different channels of the fused features may be configured as different combinations of low-frequency and high-frequency features.

In some embodiments, the method may further include merging the fused features to full-resolution features, and adding the full-resolution features to input features of the compressed image.

In some embodiments, the method may further include applying a locally-enhanced feed-forward network (LeFF) on the features to produce output features.

In some embodiments, the LeFF may be configured to perform dimensional operations and non-linear processing on the features.

In some embodiments, applying the dual branches may be performed in a framework level, extracting the high-frequency features by the HFDC may be performed in a component level, and fusing the low-frequency features and the high-frequency features by the LHAM may be performed in a module level.

According to a second aspect of the invention, there is provided a low-high frequency transformer (LHFT) module configured to perform the aforementioned computer-implemented method, which includes a self-attention mechanism for extracting low-frequency features from a compressed image, a high-frequency depth-wise convolution (HFDC) with zero-mean kernels for extracting high-frequency features, and a low-high-attention module (LHAM) for fusing the low-frequency features and the high-frequency features.

According to a third aspect of the invention, there is provided a hierarchical U-shaped encoder-decoder network with residual learning for restoring a compressed image with raindrops, which includes an input projection block to extract features from an input image, and an encoder block to extract multi-scale features, the encoder block including two or more encoder sub-blocks and a bottleneck block, wherein each encoder sub-block includes a sequential stacking of low-high frequency transformer (LHFT) modules and a down-sampling layer to reduce spatial resolution and expand channel dimension of the features, a decoder block to restore features, the decoder block including two or more decoder sub-blocks corresponding to two or more spatial resolutions, wherein each decoder sub-block includes an up-sampling layer to double the spatial resolution and reduce half of the channel, and a concatenation unit to concatenate the up-sampled features and the features from the corresponding encoder sub-block by skip-connection, and a sequential stacking of LHFT modules, an output projection block to reconstruct a residual image based on the restored features, and an addition unit to obtain a reconstructed image by adding the residual image and the input image. The LHFT modules may include the LHFT as aforementioned.

According to a fourth aspect of the invention, there is provided a system for restoring a compressed image with raindrops, which includes one or more processors, and a memory storing one or more programs configured to be executed by the one or more processors, the one or more programs including instructions for performing or facilitating performing of the computer-implemented method as aforementioned.

According to a fifth aspect of the invention, there is provided a non-transitory computer readable medium having instructions stored thereon which, when executed by one or more processors, cause the one or more processors to execute the computer-implemented method as aforementioned.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIG. 1 shows examples of ground truth images (the first column), raindrop images (the second column), and compressed raindrop images (the third column).

FIG. 2 shows an overall architecture of a hierarchical U-shaped encoder-decoder network according to an embodiment of the invention.

FIGS. 3A to 3C show different operational diagrams of existing transformers to extract low-frequency and high-frequency information.

FIG. 4 shows an operational diagram of a transformer according an embodiment of the invention.

FIG. 5A shows a schematic diagram of a high-frequency depth-wise convolution (HFDC) according to an embodiment of the invention; and FIG. 5B shows a schematic diagram of a high-frequency convolution (HFConv) according to an embodiment of the invention.

FIG. 6 shows visualization of features extracted by a vanilla Depth-wise convolution (DC) and the HFDC at the first block of the first encoder stage.

FIG. 7 shows a structure of a low-high-attention module (LHAM) including four stages: mixing, squeezing, excitation, and fusion, according to an embodiment of the invention.

FIG. 8 shows visualization of different channels in value V at the first block of the third encoder stage.

FIG. 9 presents qualitative comparison on the proposed method according to an embodiment of the invention with the exiting methods for compressed images with raindrops under QF10.

FIG. 10 presents qualitative comparison on the proposed method according to an embodiment of the invention with the exiting methods for compressed images with raindrops under QF50.

FIG. 11 shows Fourier analysis of the input value features V, the low-frequency features F^{L}, and the high-frequency features F^{H} at the first block of the first encoder stage in both backbone+DC and backbone+HFDC.

FIG. 12 shows weights w^{L} and w^{H} at the first block of the second encoder stage along channels in different local windows.

FIG. 13 shows an example information handling system in some embodiments of the invention.

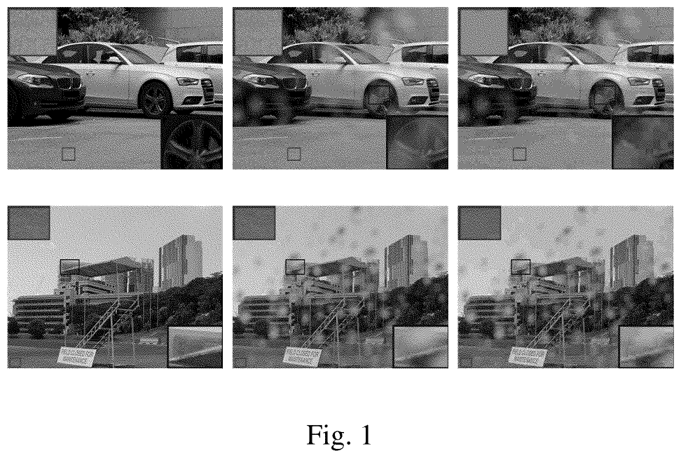

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Hereinafter, some embodiments of the invention will be described in detail with reference to the drawings.

The embodiments of the invention, at the framework level, integrate a self-attention mechanism and convolutional layers to form a low-high-frequency transformer (LHFT) with rich low and high frequencies. At the component level, the zero-mean signal structure's constraint is introduced to develop a high-frequency depth-wise convolution (HFDC). This module is high-frequency-friendly (HF-friendly), capable of extracting and restoring richer high-frequency features compared to vanilla depth-wise convolution. At the module level, a low-high-attention module (LHAM) is designed to adjust the composition of low and high frequencies by adaptively allocating the importance of the branches among channels, motivated by the observation that features of different channels tend to extract different frequencies. The main contributions are summarized as follows,
The embodiments of the invention make the first effort to address the practical raindrop removal from compressed images and establish a JPEG compressed raindrop image dataset. Extensive evaluations are conducted on this dataset with various compression rates.
The embodiments of the invention propose the novel HF-friendly transformer architecture named HFGlobalFormer for compressed image raindrop removal, integrating the high-frequency extraction capacity of convolutional layer and global contexts modeling capability of the self-attention mechanism at framework, component, and module levels. Experimental results consistently show that HFGlobalFormer outperforms existing methods without incurring additional computational costs.
The embodiments of the invention propose the LHFT at the framework level to handle the hybrid degradation, where the dual branches are introduced in a complementary manner for extracting low frequencies globally and high frequencies locally.
The embodiments of the invention propose the HFDC with zero-mean kernels at the component level for facilitating high-frequency feature extraction. The zero-mean property empowers the convolution to extract HF-dominated features.
The embodiments of the invention propose the LHAM at the module level to diverse frequency-related degradation by adaptively allocating the importance of the low and high frequencies among channels for effective feature fusion.

### RELATED WORK

A. Deep Learning-Based Raindrop Removal from a Single Image

Numerous deep learning-based methods have been proposed for removing raindrops from a single image. Eigen et al. [1] firstly utilizes a deep neural network to eliminate raindrops from a single image. Qian et al. [21]proposes the attentive generative adversarial network (GAN) to generate a raindrop-free image with the guidance of the raindrop mask. Hao et al. [3] develops a raindrop-aware neural network to detect and remove the raindrops jointly. Shao et al. [4] further explores the blurry information of raindrops and proposes the uncertainty-guided multi-scale attention network (UMAN). Moreover, Shao et al. [5] utilizes the background texture information and features of raindrops for raindrop removal. Regarding raindrops with various shapes, Quan et al. [6]proposes the shape-driven attention-based model. Liu et al. [7]proposes the dual residual networks (DuRN) for fully exploiting the information between different layers in the network. Zini et al. [7] designs the laplacian-pyramid encoder-decoder network with laplacian decomposition and alignment. However, the performance of these CNN-based methods is limited due to the inferior ability of convolution to model global information. To capture long-range information, Xiao et al. [9]proposes an image deraining transformer (IDT) with positional modeling and complementary transformer modules for both rain streak and raindrop removal. Although many efforts have been made to raindrop removal from a single image, the compressed image deraindrop is rarely investigated. It is a more challenging task for existing methods due to the complex hybrid degradation.

### B. Deep Learning-Based JPEG Artifacts Removal

Deep learning-based methods for JPEG artifacts removal achieve significant progress due to the success of CNN in many tasks. Dong et al. [19]proposes the artifacts reduction convolutional neural networks (ARCNN), the pioneering CNN-based work for JPEG artifacts removal. Svoboda et al. [20] develops a deeper residual learning-based network with better performance than ARCNN. Some works utilizes the DCT domain priors [21], [22] or wavelet information [23] to improve the performance. Galteri et al. [24] presents the GAN-based transformation method for photo-realistic textures. Zhang et al. [25]proposes an intensity-guided CNN (IGNet) model to remove the artifacts of JPEG compressed depth images. Recently, several attempts have been made to exploit the quality factor (QF) for enhancement. Kim et al. [26] estimates the QF and uses it to select the suitable removal network. Kim et al. [27] further proposes the adaptive artifacts removal system (AGARNet), where one single model for a wide range of QFs is exploited. Wang et al. [28] presents the differentiable compression quality ranker to guide the removal network. Jiang et al. [29] leverages the QF estimation branch to guide the restoration networks. Xing et al. [30]proposes the dynamic quality enhancement network and utilizes an early-exit strategy. Chen et al. [31] integrates the channel regulation with the early exit strategy, where the estimated QF is used to determine the exit stage. The existing deep learning-based JPEG artifacts removal methods are designed for the single distortion, which may not adapt well to the compressed image deraindrop problem without efficiently exploiting both the global contextual and high-frequency information.

### C. Vision Transformers

Recently, the transformer-based architecture [32], [33] has been introduced into high-level vision tasks, such as ViT [34], Swin Transformer [35], and Cswin Transformer [36]. The transformer-based image restoration also attracts much research attention. Chen et al. [37]proposes the image processing transformer (IPT) by employing the vanilla ViT for image restoration. Liang et al. [38] develops the Swin Transformer based image restoration (SwinIR) method, and Wang et al. [39]proposes the Uformer with the window-based attention mechanism and hierarchical encoder-decoder architecture. Zamir et al. [40] designs the Restoration Transformer (Restormer) to capture global relationships with linear complexity, where the cross-covariance across channels is calculated. Chen et al. [41] explores the rectangle-window self-attention and axial shift to improve the performance. For the wider receptive field, Zhang et al. [42] presents both dense and sparse attention modules for image restoration. To leverage the sample-specific properties, Ye et al. [43] introduces the external memory-augmented network (EMNet) into the transformer baseline. In addition, Ye et al. [44]proposes the CSformer architecture for compressive sensing.

### Methodology

### A. Motivation

The compressed image raindrop removal is a realistic and challenging problem, which is rarely investigated in recent advanced raindrop removal methods [1]-[9]. Given a compressed image with raindrops, the embodiments of the invention are aimed to not only remove raindrops but also restore the blurred background caused by compression, requiring both global low-frequency and local high-frequency contexts. The CNN-based methods [1]-[8] own limited receptive fields and fail to well model global contextual information. In contrast, the transformer-based method [9] focuses on capturing global dependencies but ignores the consideration of the HF information and the related low/high frequency combination. Moreover, most existing methods are designed for uncompressed or slightly compressed images, which cannot perform well on such challenging mixed degradation.

The embodiments of the invention fill the aforementioned gaps and deficiencies. The embodiments of the invention integrate frequency domain information and context modeling into the enhanced model through the following three aspects:
Combination of MSA and Convolutions. The embodiments of the invention introduce two complementary branches in the proposed HFGlobalFormer to extract low-frequency and high-frequency information by MSA and convolution layers, which are further fused together for improved performance.
Injecting Frequency Priors into Module Design. The embodiments of the invention inject the zero-mean kernel constraint into HFDC to better capture high-frequency features.
Rebalancing Different Frequencies by Recalibration. As features of different channels tend to focus on different frequencies [15], the embodiments of the invention propose to use LHAM to adjust the compositions of the complementary branches among channels adaptively for more effective fusion of low/high-frequency information.

To achieve the above-mentioned objectives, the overall framework and the detailed structure of each module will be described in the following sections.

### B. Overall Architecture

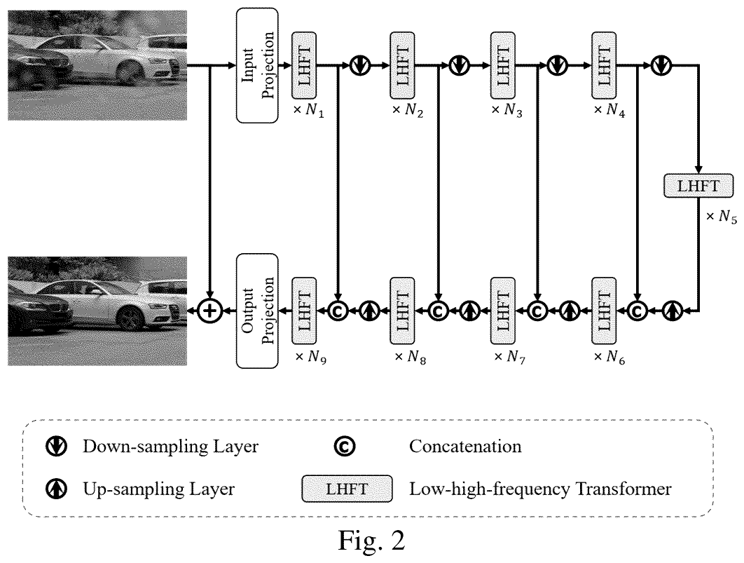

The overall architecture of the proposed HFGlobalFormer is a hierarchical U-shaped encoder-decoder network with residual learning, which consists of the input/output projection blocks, stacked proposed low-high-frequency transformer (LHFT) blocks, down/up-sampling layers, and skip-connections between the encoder/decoder phases, as depicted in FIG. 2. The number of LHFT blocks in each stage is denoted as {N₁, N₂, N₃, N₄, N₅, N₆, N₇, N₈, N₉}. Specifically, the input projection block containing a 3×3 convolutional layer with LeakyReLU is first applied to extract the features from the input image. Then, the extracted features are fed into the encoder phase including, for example, four encoder stages and one bottleneck stage. Each encoder stage is composed of a sequential stacking of LHFT blocks and a down-sampling layer. The down-sampling layer constructed by a 4×4 convolution with stride 2 is used to reduce the spatial resolution and expand the channel dimension of the features. At the end of the encoder phase, the bottleneck stage only contains a stack of LHFT blocks. The multi-scale features are extracted by the encoder phase and further fed into the decoder phase.

The decoder phase also includes, for example, four decoder stages, corresponding to four spatial resolutions. Each decoder stage first adopts the up-sampling layer with a 2×2 transposed convolution with stride 2 to double the spatial resolution and reduce half of the channel. Then, the up-sampled features and the features from the corresponding encoder stage by skip-connection are concatenated, for more effective information flow through the encoder and decoder. The concatenated features are further fed into the LHFT blocks. After the decoder phase, the restored features are fed to the output projection block with a 3×3 convolutional layer to reconstruct a residual image. Finally, the reconstructed image is obtained by adding the residual image and the input image.

### C. Low-High-Frequency Transformer (LHFT)

The restoration of compressed images with raindrops is challenging since both the obscured regions under raindrops and high-frequency detail loss caused by the compression should be recovered, requiring sufficient extraction and interaction of both global low-frequency and local high-frequency information.

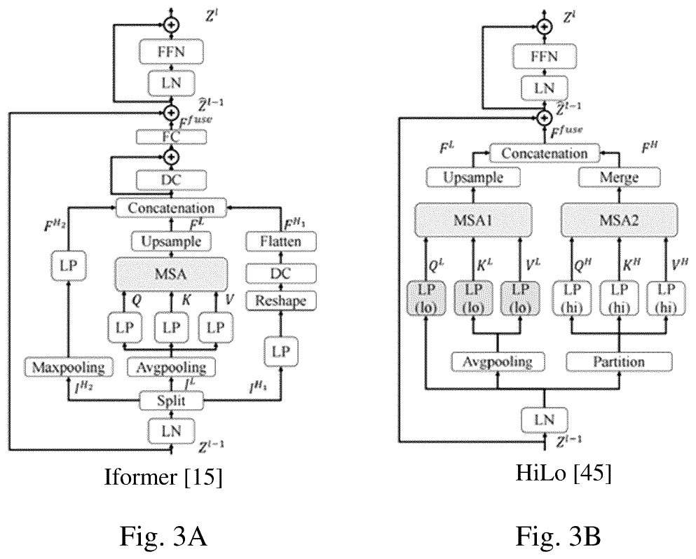

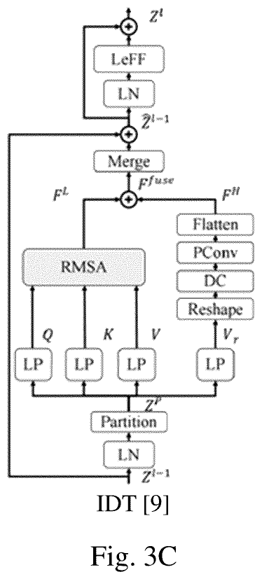

Recent transformer-based works have been devoted to the effective utilization of low-frequency and high-frequency information, such as inception transformer (IFormer) [15], high-low-attention transformer (HiLo) [45], and image deraining transformer (IDT) [9]. FIGS. 3A to 3C show different operational diagrams of transformers to extract low-frequency and high-frequency information according to the inception transformer (IFormer) [15], high-low-attention transformer (HiLo) [45], and image deraining transformer (IDT) [9], respectively. LN and LP represent layer normalization and linear projection, respectively. FFN and LeFF represent the feed-forward network and locally-enhanced feed-forward network, respectively. PConv is the point-wise convolution. It is noted that IFormer and HiLo are designed for high-level vision tasks. As shown in FIG. 3A, IFormer utilizes the max-pooling operation and depth-wise convolution (DC) to capture high-frequency features. For low-frequency features, the multi-head self-attention (MSA) is leveraged. As shown in FIG. 3B, HiLo utilizes two MSAs to capture low-frequency and high-frequency information. As shown in FIG. 3C, IDT utilizes the DC to model high-frequency information and the relative position multi-head self-attention (RMSA) to capture global low-frequency information. Although the performance has been improved through the cooperation between MSA and convolution, the HF-friendly design and the efficient fusion of low-frequency and high-frequency information are not well explored.

To address the complex hybrid degradation, the embodiments of the invention propose the LHFT, which leverages self-attention (for example, RMSA) to capture global low-frequency information, the HFDC with the high-frequency-friendly design to extract high-frequency features (i.e., to model local high-frequency details), and the LHAM to achieve effective fusion of low-frequency and high-frequency information. Then, the LeFF [39], [46] is used to perform dimensional operations and non-linear processing on the features, which consists of a 3×3 depth-wise convolution between two linear projection layers.

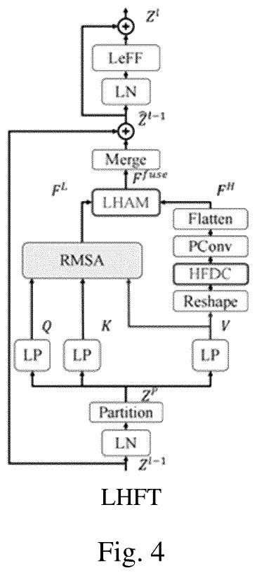

Specifically, as shown in FIG. 4, the layer normalization (LN) is employed first to the input features Z^{l-1}∈ [symbol] of block l and the normalized features are partitioned into non-overlapping windows to obtain the features Z^{P}∈

$${ℝ}^{\frac{HW}{{M}^{2}} \times {M}^{2} \times C} :$$

$${Z}^{P} = Partition ( LN ( {Z}^{l - 1} ) ) , \qquad ( 1 )$$

where Z^{l-1} also denotes the output features of block l−1. Then, three linear projection layers with the reshaping operation are applied to generate Q, K, V

$$∈ {ℝ}^{\frac{HW}{{M}^{2}} \times m \times {M}^{2} \times d} :$$

$$Q , K , V = Reshape ( {Z}^{P} {W}_{Q} , {Z}^{P} {W}_{K} , {Z}^{P} {W}_{V} ) , \qquad ( 2 )$$

where W_{Q}, W_{K}, W_{V} [symbol] are the projection matrices, which are shared across the windows. Q, K, V represent the query, key, and value for self-attention. m denotes the number of heads, and the head dimension is d=C/m.

In order to capture the global low-frequency and the local high-frequency features, the value V is fed to the complementary branches. It is noted that two complementary branches are performed in each local window since the input features are partitioned. For extracting low-frequency information, the RMSA [35] with the reshaping operation is applied to obtain the low-frequency features F^{L}∈

$${ℝ}^{\frac{HW}{{M}^{2}} \times {M}^{2} \times C} :$$

$${F}^{L} = Reshape ( Softmax ( \frac{{QK}^{T}}{\sqrt{d}} + B ) V ) , \qquad ( 3 )$$

where B is the learnable relative position encoding. The attention operation is parallelly performed on each head, and the result is further reshaped to the size of the features Z^{P}. For effectively capturing the high-frequency features, the value V is input to the high-frequency branch, which is composed of the reshaping/flattening operation, the HFDC, and the 1×1 PConv. To facilitate the convolution operation, the value V is reshaped to 2D features of size

$$\frac{HW}{{M}^{2}} \times C \times M \times M .$$

Next, the proposed HFDC and PConv are successively employed to obtain high-frequency features, which can be regarded as the high-frequency depth-wise separable convolution. Finally, the high-frequency features are flattened to F^{H}∈

$${ℝ}^{\frac{HW}{{M}^{2}} \times {M}^{2} \times C}$$

of the same size of F^{L}. The whole high-frequency branch can be formulated as:

$${F}^{H} = Flatten ( ( PConv ( HFDC ( Reshape ( V ) ) ) ) . \qquad ( 4 )$$

After the complementary branches, F^{L} and F^{H} are fused by the LHAM. Then, the fused features are merged to the full-resolution features of size H×W×C. Then, the merged features and Z^{l-1} are added to get the features \hat{Z}^{l-1}:

$${\hat{Z}}^{l - 1} = {Z}^{l - 1} + Merge ( LHAM ( {F}^{L} , {F}^{H} ) ) . \qquad ( 5 )$$

Following [9], [39], the LeFF is applied as the feed-forward network after the LN to produce the output features Z^{l}∈ [symbol] of the proposed LHFT:

$${Z}^{l} = {\hat{Z}}^{l - 1} + LeFF ( LN ( {\hat{Z}}^{l - 1} ) ) . \qquad ( 6 )$$

### D. High-Frequency Depth-Wise Convolution (HFDC)

The restoration of high-frequency information is critical in compressed image raindrop removal. Although Park et al. [13] has revealed that the convolution acts more like a high-pass filter, the effectiveness of extracting high-frequency features can be improved since the response of the vanilla convolution may contain the direct current bias (the major low-frequency information) of the input due to the lack of constrain on kernels. The kernels of traditional high-pass filters, such as Prewitt [16], Sobel [17], and LoG [18] operators, always have the zero-mean property [47]-[50]. In [48], the authors illustrate that this property can help suppress the response caused by the direct current bias in the input, which can be explained by the frequency decomposition.

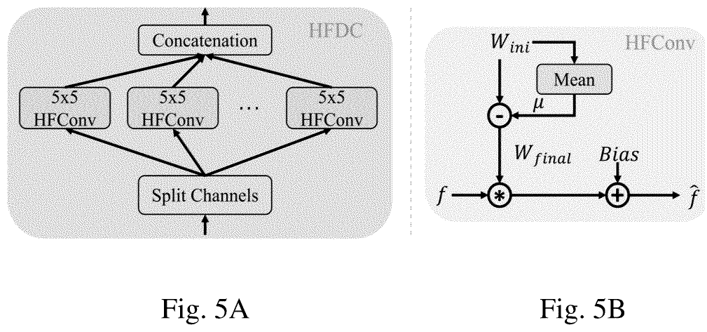

HFDC. To capture the high-frequency features more efficiently, the zero-mean property is introduced into the high-frequency depth-wise convolution (HFDC). The vanilla depth-wise convolution proposed in the Xception [51] framework treats each input channel independently, which can improve learning efficiency and reduce computation overhead. Some embodiments of the invention propose the HFDC by replacing the vanilla convolution with a high-frequency convolution (HFConv) with zero-mean kernels to extract the feature of each channel. As shown in FIG. 5A, the input is split into multiple channels, and each channel is convolved with a 5×5 HFConv. The result is the concatenation of features from each channel.

HFConv. HFConv is the key component of the proposed HFDC, which aims to extract high-frequency features from the input. As indicated in FIG. 5B, f and \hat{f} represent the input and output signal of HFConv, respectively. Wᵢₙᵢ denotes the initial kernels, which are learnable parameters. W_{final} is obtained by removing the spatial mean from Wᵢₙᵢ and applied to convolve with the input. Finally, the output \hat{f} is generated by adding the convolved result and Bias. The processing inside the HFConv can be formulated as:

$${W}_{final} = {W}_{ini} - Mean ( {W}_{ini} ) , \qquad ( 7 )$$

$$\hat{f} = f * {W}_{final} + Bias . \qquad ( 8 )$$

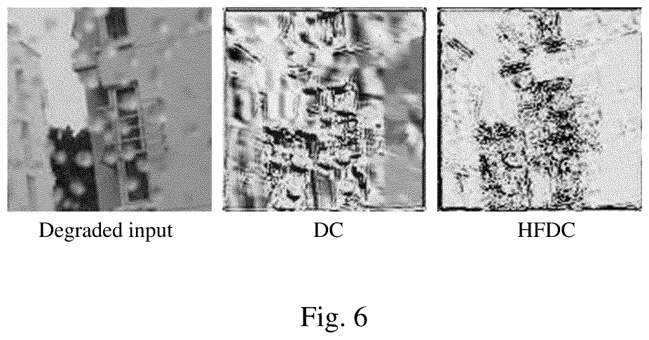

For further understanding of the proposed HFDC, the feature maps visualization is presented in FIG. 6. The degraded input patch and the features extracted by the vanilla Depth-wise convolution (DC) and HFDC at the first block of the first encoder stage are visualized. As can be seen, HFDC can focus more on the high-frequency information and keep the sharp texture details while the features extracted by DC still contain some low-frequency regions. Moreover, HFDC can extract the structure information and suppress the effects of raindrops.

### E. Low-High-Attention Module (LHAM)

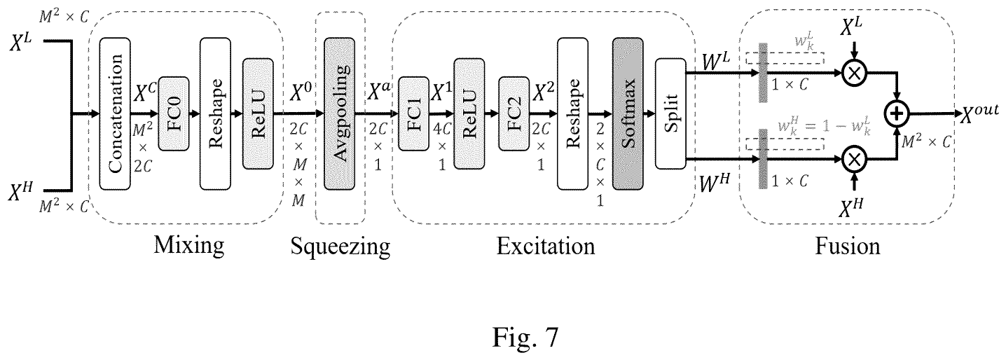

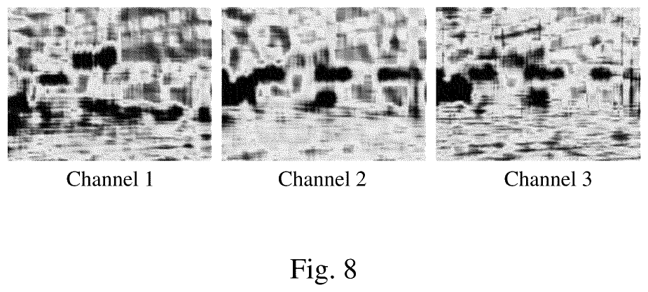

Compressed images with raindrops contain diverse degradation on different contents caused by the diverse raindrops and compression mechanism. Specifically, the raindrops with different shapes and sizes obscure the background variously, and the obscured contents are various due to the random positions of the raindrops. The distortion caused by compression varies in regions with different textures since more high-frequency information is always lost in the areas with complex textures compared to the smooth regions. Moreover, as demonstrated in [15], features of different channels always tend to focus on different frequencies, which can be observed in FIG. 8. Features of channels 1 and 3 contain more high frequencies than the feature of channel 2. Although the complementary branches in the proposed LHFT efficiently extract low/high frequencies, the model adaptability of contents and channels remains to be explored. To this end, some embodiments of the invention propose the LHAM to fuse the low-frequency and high-frequency features by adaptively allocating the importance of the branches among channels. Moreover, the proposed LHAM is a window-wise attention scheme, which is performed in each local window as shown in FIG. 4. To simplify, the process inside a local window is presented in FIG. 7, including four stages: mixing, squeezing, excitation, and fusion.

Mixing. Given the local window low-frequency features X^{L}∈ [symbol] from F^{L} and high-frequency features X^{H}∈ [symbol] from F^{H}, they are concatenated first and the fully connected layer FC0 is utilized to mix the information from two branches. Then, the integrated features are reshaped into spatial features, which are further fed to the ReLU layer to obtain the mixed features X⁰∈ [symbol] . The mixing stage can be formulated as:

$${X}^{C} = Concatenation ( {X}^{L} , {X}^{H} ) , \qquad ( 9 )$$

$${X}^{0} = ReLU ( Reshape ( FC 0 ( {X}^{c} ) ) ) . \qquad ( 10 )$$

Squeezing. The squeezing stage aims to aggregate spatial information by applying average pooling on each channel:

$${X}^{a} = Avgpooling ( {X}^{0} ) . \qquad ( 11 )$$

Excitation. The compact features X^{a}∈ [symbol] are subject to the excitation stage for obtaining the weight matrices for X^{L} and X^{H}, respectively. Specifically, the fully connected layer FC1 is employed to process the input and double the channels. Next, a ReLU layer and another fully connected layer FC2 are applied to shrink and merge the expanded features X¹∈ [symbol] . The shrunk features X²∈ [symbol] are reshaped and fed to a softmax layer. Finally, the generated matrix of size 2×C×1 is split into two weight matrices W^{L}∈ [symbol] and W^{H}∈ [symbol] . The whole process of the excitation stage is presented as:

$${X}^{2} = FC 2 ( ReLU ( FC 1 ( {X}^{a} ) ) ) , \qquad ( 12 )$$

$${W}^{L} , {W}^{H} = Split ( Softmax ( Reshape ( {X}^{2} ) ) ) . \qquad ( 13 )$$

Fusion. The fusion stage aims to generate the weighted low-frequency and high-frequency features and fuse them. The channel-wise multiplication is performed on the features and their corresponding weight matrix. Finally, the element-wise addition is used to generate the fused features X^{out}∈ [symbol] . In conclusion, different channels of the fused features are the different combinations of low-frequency and high-frequency features. The fusion process can be formulated as:

$${x}_{k}^{out} = {x}_{k}^{L} * {w}_{k}^{L} + {x}_{k}^{H} * {w}_{k}^{H} , k = 1 , 2 , … , C , \qquad ( 14 )$$

where xₖ^{L}, xₖ^{H} and xₖ^{out} represent the k-th channel of X^{L}, X^{H} and X^{out}, respectively. wₖ^{L} and wₖ^{H} denote the k-th channel of W^{L} and W^{H}, respectively. Moreover, wₖ^{H}=1−wₖ^{L} due to the softmax layer.

### EXPERIMENTS AND ANALYSIS

### A. Experimental Settings

1) JPEG compressed raindrop image dataset: To facilitate the training and evaluate the performance of removing the raindrops from the compressed images, the JPEG compressed raindrop image dataset is constructed. The JPEG compressed raindrop image dataset is based on the one created by Qian et al. [2]. Qian et al. collects the raindrop/clean image pairs by taking photos through two pieces of glass, where one is clean and the other is splashed with water. Following the settings in the existing raindrop removal methods, 861 image pairs are utilized for training and 58 well-aligned image pairs in the Test_a are utilized for testing. Moreover, all the raindrop images are compressed with JPEG under five quality factors (QFs) {10, 20, 30, 40, 50}, such that the image pairs (compressed raindrop and clean images) are obtained and five sub-datasets are collected.

2) Implementation: In this disclosure, some embodiments of the invention train one model per QF from scratch and conduct the testing for each QF, aiming to demonstrate the effectiveness of the proposed HFGlobalFormer on various compression rates. During the training, the training images are randomly cropped into 128×128 patches and the random flips on horizontal and vertical directions are applied to augment the data. The learning rate and the batch size are set to 1e⁻⁴ and 4, respectively. The Adam optimizer [52] is employed for 8.6×10⁵ steps to train the network. In one example, the proposed HFGlobalFormer contains 4 encoder stages, 1 bottleneck stage, and 4 decoder stages. In the experiments, the number of LHFT blocks in each stage, denoted as {N₁, N₂, N₃, N₄, N₅, N₆, N₇, N₈, N₉}, is set to {3, 3, 2, 2, 1, 1, 2, 2, 3}. The number of heads for each stage is set to {1, 2, 4, 8, 16, 16, 8, 4, 2}, and the head dimension d is set to 32.

3) Loss function: Following the loss function in IDT [9], the single negative SSIM [53] is utilized on RGB channels to guide the training:

$$L = - SSIM ( {I}_{Degraded} , {I}_{GT} ) , \qquad ( 15 )$$

where I_{Degraded} and I_{GT} denote the compressed raindrop image and the ground truth image, respectively.

### B. Performance Comparison

Comparison settings: The proposed HFGlobalFormer is compared with some existing raindrop removal methods, including AttenGAN [2], RaindropAtten [6], DuRN [7], and IDT [9]. For a fair comparison, all the models are retrained using their released codes since their pre-trained models for the single raindrop removal task fail to adapt to the restoration of compressed images with raindrops well. For each method, five models corresponding to five QFs are also trained and the evaluation is performed on each QF. Following the existing raindrop removal methods, PSNR and SSIM are calculated on the Y channel of YCbCr space.

Quantitative results: The quantitative evaluations on the JPEG compressed raindrop image dataset for compressed image raindrop removal are reported in Table I. As can be seen, the proposed method outperforms the existing methods in terms of both PSNR and SSIM on average. Moreover, the proposed method also achieves the best performance on QF20, QF30, QF40, and QF50, demonstrating the generalization capability on various compression rates. For the case QF10, the proposed method surpasses the RaindropAtten [6] by a large margin in terms of SSIM and the results in terms of PSNR are also comparable.

TABLE I
QUANTITATIVE COMPARISON WITH THE EXISTING METHODS FOR COMPRESSED IMAGE DERAINDROP.
THE BEST AND SECOND BEST RESULTS ARE MARKED IN BRACKET AND UNDERLINE.

| | Degraded | | AttenGAN [2] | | RaindropAtten [6] | | DuRN [7] | | IDT [9] | | Proposed | |
|---|---|---|---|---|---|---|---|---|---|---|---|---|
| Methods | PSNR | SSIM | PSNR | SSIM | PSNR | SSIM | PSNR | SSIM | PSNR | SSIM | PSNR | SSIM |
| QF10 | 23.02 | 0.6810 | 25.40 | 0.7069 | (26.83) | 0.7566 | 26.45 | 0.7675 | 26.74 | 0.7705 | 26.82 | (0.7741) |
| QF20 | 23.44 | 0.7417 | 26.23 | 0.7637 | 27.93 | 0.8058 | 27.62 | 0.8181 | 27.92 | 0.8224 | (28.04) | (0.8265) |
| QF30 | 23.60 | 0.7677 | 26.65 | 0.7965 | 28.32 | 0.8288 | 28.36 | 0.8396 | 28.53 | 0.8453 | (28.94) | (0.8508) |
| QF40 | 23.70 | 0.7823 | 27.03 | 0.8113 | 28.88 | 0.8429 | 28.40 | 0.8510 | 28.80 | 0.8575 | (28.98) | (0.8623) |
| QF50 | 23.77 | 0.7928 | 27.16 | 0.8146 | 29.03 | 0.8549 | 28.70 | 0.8613 | 29.08 | 0.8678 | (29.29) | (0.8722) |
| Average | 23.51 | 0.7531 | 26.49 | 0.7786 | 28.20 | 0.8178 | 27.91 | 0.8275 | 28.21 | 0.8327 | (28.42) | (0.8372) |

Compared with IDT, the second best performance on average, the proposed method achieves obvious improvement. For compressed image raindrop removal, the proposed method benefits from the efficient collaboration between the self-attention mechanism and high-frequency-friendly design, which improves the capacity to utilize both low-frequency and high-frequency information. Moreover, the adaptive fusion of the low/high-frequency features is employed in the proposed method, leading to improved performance on diverse and complex degradation. Compared with the CNN-based methods (AttenGAN, RaindropAtten, and DuRN), remarkable gains in terms of PSNR and SSIM on average can be observed. The limited capacity in modeling global dependencies of CNN-based methods prevents them from efficiently removing raindrops with complicated shapes and appearances.

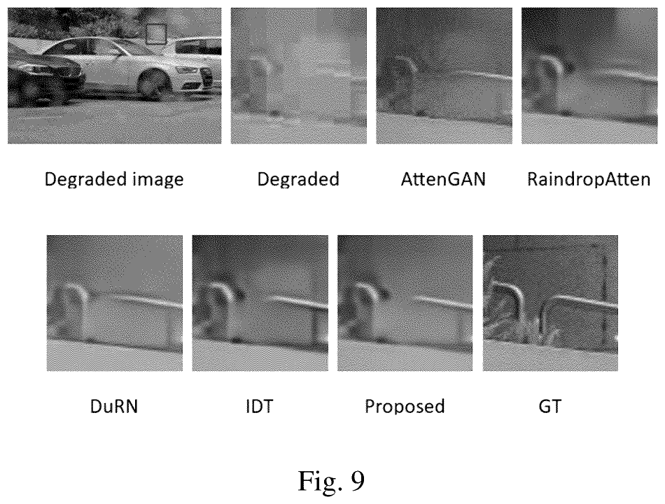

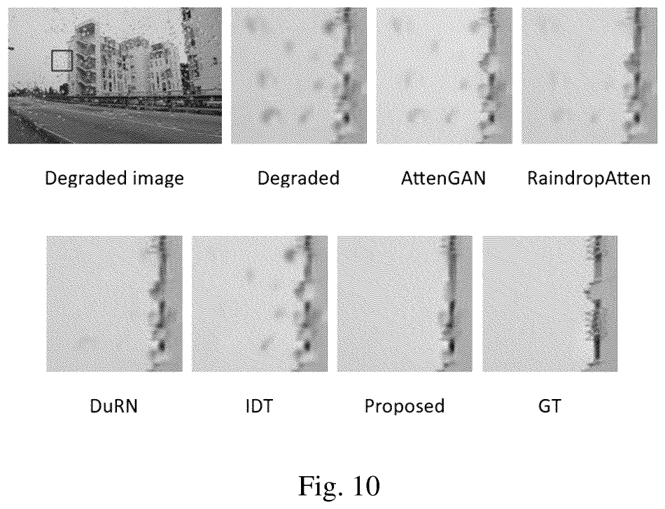

3) Qualitative results: The qualitative comparison results of different methods for compressed image raindrop removal are provided to demonstrate the effectiveness of the proposed method. In FIGS. 9 and 10, the visual results of the existing methods and the proposed method on QF10 and QF50 are presented, respectively. Regarding the highly compressed images with raindrops under QF10, it can be observed that cropped regions in degraded input images contain strong blocking artifacts and severe occlusions by the irregular raindrops due to the compression. As can be observed in FIG. 9, the proposed method can alleviate the raindrops obviously and recover more textures from the highly distorted input image. In contrast, the compared methods still suffer from the raindrop effects and fail to reconstruct image details. Regarding the compressed images with raindrops under QF50, the regions with dense raindrops and complicated structures like buildings are selected to verify the restoration capability of the proposed method. As shown in FIG. 10, the proposed method can remove the raindrops effectively. These visual results demonstrate that the proposed HFGlobalFormer has the stronger representation capability to remove raindrops and recover textural details through the efficient utilization and fusion of global contextual and high-frequency information.

4) Complexity comparison: The complexity comparison of the existing methods and the proposed method are reported in Table II. The MACs (multiply-accumulate operations) are calculated on the image of size 3×128×128. As can be seen, the proposed method achieves the lowest computation complexity and the best performance for compressed image raindrop removal, demonstrating our superior efficiency.

TABLE II
COMPLEXITY COMPARISON WITH THE EXISTING METHODS.
THE MACS ARE CALCULATED ON A 3 × 128
× 128 IMAGE.

| Methods | AttenGAN | RaindropAtten | DuRN | IDT | Proposed |
|---|---|---|---|---|---|
| MACs/G | 22.35 | 16.57 | 14.02 | 14.48 | 13.75 |

### C. Ablation Studies

The ablation studies are conducted to evaluate the effectiveness of each important component in the proposed HFGlobalFormer. The same experimental settings are adopted as described before. SSIM is utilized to evaluate the performance since it is the loss function of the proposed method and can reflect the capability of restoring the structure information. The high-frequency branch and LHAM are removed in all the proposed LHFT blocks of HFGlobalFormer, resulting in the backbone network. Then, the vanilla depth-wise convolution (DC) is utilized to construct the high-frequency branch instead of the proposed HFDC upon the backbone to investigate the influence of the high-frequency branch without the HF-friendly design, denoted as backbone+DC. To evaluate the effectiveness of the proposed HFDC, the vanilla depth-wise convolution is replaced with the proposed HFDC in backbone+DC, denoted as backbone+HFDC. Finally, the LHAM is employed upon backbone+HFDC to form the proposed overall method backbone+HFDC+LHAM.

1) The effectiveness of the high-frequency branch without the HF-friendly design: It is aimed to explore the efficient collaboration between the self-attention mechanism and convolution to extract low-frequency and high-frequency features. To this end, the value in the local window is fed to the low-frequency and high-frequency branches. The performance is compared between backbone and backbone+DC to show the effectiveness of the high-frequency branch without the HF-friendly design. From Table III, it is found that introducing the vanilla depth-wise convolution-based high-frequency branch can bring gains on average. However, worse performance can be observed in QF20, and similar results in QF40 and QF50 are reported. The lack of the HF-friendly design leads to limited improvements, such that the HFDC is developed to improve the capacity to extract high-frequency features.

TABLE III
ABLATION STUDY ON DIFFERENT COMPONENTS OF
THE PROPOSED METHOD IN TERMS OF SSIM.

| Networks | QF10 | QF20 | QF30 | QF40 | QF50 | Average |
|---|---|---|---|---|---|---|
| Backbone | 0.7714 | 0.8251 | 0.8461 | 0.8610 | 0.8710 | 0.8349 |
| Backbone + DC | 0.7727 | 0.8240 | 0.8486 | 0.8611 | 0.8711 | 0.8355 |
| Backbone + HFDC | 0.7739 | 0.8256 | 0.8488 | 0.8622 | 0.8721 | 0.8365 |
| Backbone + HFDC + LAHM | 0.7741 | 0.8265 | 0.8508 | 0.8623 | 0.8722 | 0.8372 |

2) The effectiveness of HFDC: The zero-mean property is introduced into the proposed HFDC, which can prevent the direct current bias and focus on the high-frequency information. In Table III, it is observed that backbone+HFDC can yield obvious improvements on various quality factors compared to backbone and backbone+DC, demonstrating the effectiveness of HFDC.

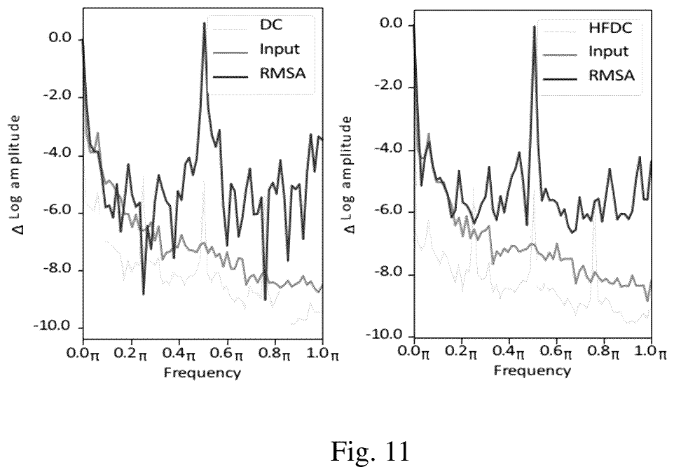

To illustrate the influence from the frequency domain, the Fourier analysis is plotted in FIG. 11. The Discrete Fourier Transform (DFT) is conducted on the input value features V, the low-frequency features F^{L}, and the high-frequency features F^{H} at the first block of the first encoder stage in both backbone+DC and backbone+HFDC. Following [13], the relative log amplitudes of the Fourier transformed feature map (the differences between the log amplitude at 0.0π and at 1.0π) are presented. To facilitate the visualization, the half-diagonal components of 2D Fourier transformed feature maps are provided. As shown in FIG. 11, RMSA tends to discard high-frequency signals, while both the DC and HFDC act like high-pass filters. However, it can be observed that HFDC can amplify the high-frequency information more than DC with more focus on the high-frequency components guided by the zero-mean property.

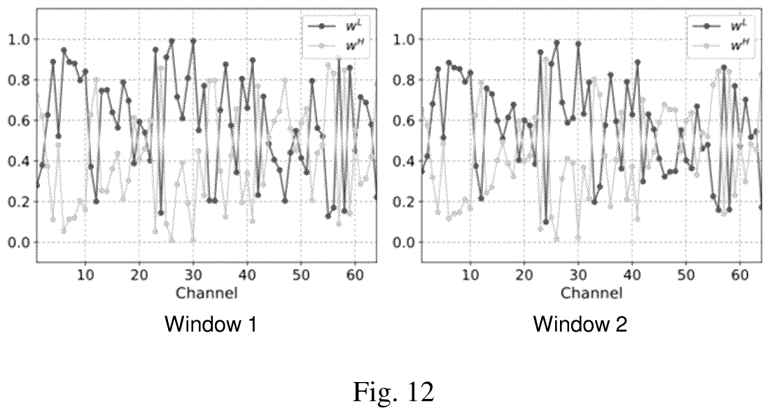

3) The effectiveness of LHAM: The proposed LHAM aims to achieve the effective fusion of low-frequency and high-frequency information by assigning the channel-wise and window-wise weights for low-frequency and high-frequency branches according to the feature characteristics. As depicted in Table III, the proposed LHAM can further improve the performance upon backbone+HFDC, which demonstrates its effectiveness. The weights w^{L} and w^{H} at the first block of the second encoder stage are presented in FIG. 12, where the channel number is 64 and two windows are selected. As can be seen, the weights for low-frequency and high-frequency branches vary among channels, where some channels focus more on low-frequency information while others concentrate more on high-frequency information. Regarding the weights in different local windows, the specific proportions of complementary branches are different, indicating that the proposed LHAM can adaptively adjust the allocations in terms of channel properties and window contents.

### CONCLUSION

When transmission medium and compression degradation are intertwined, new challenges emerge. The embodiments of the invention address the problem of raindrop removal from compressed images, where raindrops obscure large areas of the background and compression leads to the loss of high-frequency (HF) information. The restoration of the former requires global contextual information, while the latter necessitates guidance for high-frequency details, resulting in a conflict in utilizing these two types of information when designing existing methods. To address this issue, proposed is a novel transformer architecture that leverages the advantages of attention mechanism and HF-friendly design to effectively restore the compressed raindrop images at the framework, component, and module levels. Specifically, at the framework level, relative position multi-head self-attention and convolutional layers are integrated into the proposed LHFT, where the former captures global contextual information and the latter focuses on high-frequency information. Their combination effectively resolves the issue of mixed degradation. At the component level, the HFDC with zero-mean kernels is utilized to improve the capability to extract high-frequency features. Finally, at the module level, the LHAM is introduced to adaptively allocate the importance of low and high frequencies along channels for effective fusion. The JPEG-compressed raindrop image dataset is established and extensive experiments on different compression rates are conducted. Experimental results demonstrate that the proposed method embodiments outperform the existing methods without increasing computational costs.

To summarize, the embodiments of the invention provide a novel architecture, so called, HFGlobalFormer that pursues the effective restoration of the compressed image with raindrops. With the LHFT, the self-attention mechanism and the convolutional layer cooperate effectively to capture complementary global contextual information and high-frequency information at the framework level, benefiting the restoration of largely obscured areas by raindrops and lost high-frequency details by compression. To improve the capability to extract high-frequency features, the HFDC with the zero-mean property is developed as the important component in LHFT. With the help of the LHAM, the effective fusion of the low-frequency and high-frequency information is obtained, adapting to diverse degradation for compressed image raindrop removal. Extensive experimental results demonstrate the superior performance of the proposed method compared to the existing methods.

### System

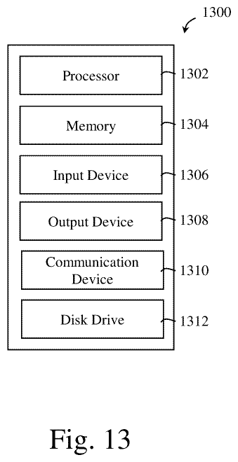

FIG. 13 shows an example information handling system 1300 that can be used to perform one or more of the methods for restoring a compressed image with raindrops in embodiments of the invention. The information handling system 1300 generally comprises suitable components necessary to receive, store, and execute appropriate computer instructions, commands, and/or codes. The main components of the information handling system 1300 are a processor 1302 and a memory (storage) 1304. The processor 1302 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The memory 1304 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 1304. Computer instructions for executing or facilitating executing the method embodiments of the invention may be stored in the memory 1304. The processor 1302 and memory (storage) 1304 may be integrated or separated (and operably connected). Optionally, the information handling system 1300 further includes one or more input devices 1306. Example of such input device 1306 include: keyboard, mouse, stylus, image scanner, microphone, tactile/touch input device (e.g., touch sensitive screen), image/video input device (e.g., camera), etc. Optionally, the information handling system 1300 further includes one or more output devices 1308. Example of such output device 1308 include: display (e.g., monitor, screen, projector, etc.), speaker, headphone, earphone, printer, additive manufacturing machine (e.g., 3D printer), etc. The display may include a LCD display, a LED/OLED display, or other suitable display, which may or may not be touch sensitive. The information handling system 1300 may further include one or more disk drives 1312 which may include one or more of: solid state drive, hard disk drive, optical drive, flash drive, magnetic tape drive, etc. A suitable operating system may be installed in the information handling system 1300, e.g., on the disk drive 1312 or in the memory 1304. The memory 1304 and the disk drive 1312 may be operated by the processor 1302. Optionally, the information handling system 1300 also includes a communication device 1310 for establishing one or more communication links (not shown) with one or more other computing devices, such as servers, personal computers, terminals, tablets, phones, watches, IoT devices, or other wireless computing devices. The communication device 1310 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, above 5G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 1302, the memory 1304 (optionally the input device(s) 1306, the output device(s) 1308, the communication device(s) 1310 and the disk drive(s) 1312, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. A person skilled in the art would appreciate that the information handling system 1300 shown in FIG. 13 is merely an example and that the information handling system 1300 can in other embodiments have different configurations (e.g., include additional components, has fewer components, etc.).

Although not required, one or more embodiments described with reference to the Figures can be implemented as an application programming interface (API) or as a series of libraries for use by a developer or can be included within another software application, such as a terminal or computer operating system or a portable computing device operating system. In one or more embodiments, as program modules include routines, programs, objects, components, and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings).

### REFERENCES

[1] D. Eigen, D. Krishnan, and R. Fergus, “Restoring an image taken through a window covered with dirt or rain,” in Proceedings of the IEEE/CVF International Conference on Computer Vision, 2013, pp. 633-640.
[2] R. Qian, R. T. Tan, W. Yang, J. Su, and J. Liu, “Attentive generative adversarial network for raindrop removal from a single image,” in Proceedings of the IEEE/CVF Conference on Computer Vision and Pattern Recognition, 2018, pp. 2482-2491.
[3] Z. Hao, S. You, Y. Li, K. Li, and F. Lu, “Learning from synthetic photorealistic raindrop for single image raindrop removal,” in Proceedings of the IEEE/CVF International Conference on Computer Vision Workshop, 2019, pp. 4340-4349.
[4] M.-W. Shao, L. Li, D.-Y. Meng, and W.-M. Zuo, “Uncertainty guided multi-scale attention network for raindrop removal from a single image,” IEEE Transactions on Image Processing, vol. 30, pp. 4828-4839, 2021.
[5] M. Shao, L. Li, H. Wang, and D. Meng, “Selective generative adversarial network for raindrop removal from a single image,” Neurocomputing, vol. 426, pp. 265-273, 2021.
[6] Y. Quan, S. Deng, Y. Chen, and H. Ji, “Deep learning for seeing through window with raindrops,” in Proceedings of the IEEE/CVF International Conference on Computer Vision, 2019, pp. 2463-2471.
[7] X. Liu, M. Suganuma, Z. Sun, and T. Okatani, “Dual residual networks leveraging the potential of paired operations for image restoration,” in Proceedings of the IEEE/CVF Conference on Computer Vision and Pattern Recognition, 2019, pp. 7000-7009.
[8] S. Zini and M. Buzzelli, “Laplacian encoder-decoder network for raindrop removal,” Pattern Recognition Letters, vol. 158, pp. 24-33, 2022.
[9] J. Xiao, X. Fu, A. Liu, F. Wu, and Z.-J. Zha, “Image de-raining transformer,” IEEE Transactions on Pattern Analysis and Machine Intelligence, pp. 1-18, 2022.
[10] G. Wallace, “The JPEG still picture compression standard,” IEEE Transactions on Consumer Electronics, vol. 38, no. 1, pp. xviii-xxxiv, 1992.
[11] M. Rabbani and R. Joshi, “An overview of the jpeg 2000 still image compression standard,” Signal processing: Image communication, vol. 17, no. 1, pp. 3-48, 2002.
[12] F. Bellard, “BPG image fromat,” 2015. [Online]. Available: https://bellard.org/bpg/
[13] N. Park and S. Kim, “How do vision transformers work?” in International Conference on Learning Representations, 2022.
[14] J. Bai, L. Yuan, S.-T. Xia, S. Yan, Z. Li, and W. Liu, “Improving vision transformers by revisiting high-frequency components,” in Computer Vision-ECCV 2022. Springer, 2022, pp. 1-18.
[15] C. Si, W. Yu, P. Zhou, Y. Zhou, X. Wang, and S. YAN, “Inception transformer,” Advances in Neural Information Processing Systems, 2022.
[16] J. M. Prewitt et al., “Object enhancement and extraction,” Picture processing and Psychopictorics, vol. 10, no. 1, pp. 15-19, 1970.
[17] I. Sobel and G. Feldman, “A 3×3 isotropic gradient operator for image processing,” Pattern Classification and Scene Analysis, pp. 271-272, 01 1973.
[18] D. Marr and E. Hildreth, “Theory of edge detection,” Proceedings of the Royal Society of London. Series B. Biological Sciences, vol. 207, no. 1167, pp. 187-217, 1980.
[19] C. Dong, Y. Deng, C. C. Loy, and X. Tang, “Compression artifacts reduction by a deep convolutional network,” in Proceedings of the IEEE/CVF International Conference on Computer Vision, 2015, pp. 576-584.
[20] P. Svoboda, M. Hradis, D. Barina, and P. Zemcik, “Compression artifacts removal using convolutional neural networks,” arXiv preprint arXiv: 1605.00366, 2016.
[21] J. Guo and H. Chao, “Building dual-domain representations for compression artifacts reduction,” in Computer Vision-ECCV 2016. Springer, 2016, pp. 628-644.
[22] X. Zhang, W. Yang, Y. Hu, and J. Liu, “DMCNN: Dual-domain multiscale convolutional neural network for compression artifacts removal,” in 2018 25th IEEE International Conference on Image Processing, 2018, pp. 390-394.
[23] H. Chen, X. He, L. Qing, S. Xiong, and T. Q. Nguyen, “DPW-SDNet: Dual pixel-wavelet domain deep CNNs for soft decoding of JPEG compressed images,” in Proceedings of the IEEE/CVF Conference on Computer Vision and Pattern Recognition Workshops, 2018, pp. 711-720.
[24] L. Galteri, L. Seidenari, M. Bertini, and A. D. Bimbo, “Deep universal generative adversarial compression artifact removal,” IEEE Transactions on Multimedia, vol. 21, no. 8, pp. 2131-2145, 2019.
[25] P. Zhang, X. Wang, Y. Zhang, L. Ma, J. Jiang, and S. Kwong, “Compression artifacts reduction for depth map by deep intensity guidance,” in Advances in Multimedia Information Processing-PCM 2017. Springer, 2018, pp. 863-872.
[26] Y. Kim, J. W. Soh, J. Park, B. Ahn, H.-S. Lee, Y.-S. Moon, and N. I. Cho, “A pseudo-blind convolutional neural network for the reduction of compression artifacts,” IEEE Transactions on Circuits and Systems for Video Technology, vol. 30, no. 4, pp. 1121-1135, 2019.
[27] Y. Kim, J. W. Soh, and N. I. Cho, “AGARNet: adaptively gated JPEG compression artifacts removal network for a wide range quality factor,” IEEE Access, vol. 8, pp. 20160-20170, 2020.
[28] M. Wang, X. Fu, Z. Sun, and Z.-J. Zha, “JPEG artifacts removal via compression quality ranker-guided networks,” in Proceedings of the TwentyNinth International Conference on International Joint Conferences on Artificial Intelligence, 2021, pp. 566-572.
[29] J. Jiang, K. Zhang, and R. Timofte, “Towards flexible blind JPEG artifacts removal,” in Proceedings of the IEEE/CVF International Conference on Computer Vision, 2021, pp. 4997-5006.
[30] Q. Xing, M. Xu, T. Li, and Z. Guan, “Early exit or not: Resource efficient blind quality enhancement for compressed images,” in Computer Vision-ECCV 2020. Springer, 2020, pp. 275-292.
[31] Y. Chen, Y. Liu, M. Chen, Z. Wang, W. Yang, and Q. Liao, “Blind JPEG compression artifacts removal by integrating channel regulation with exit strategy,” IEEE Transactions on Multimedia, pp. 1-14, 2022.
[32] A. Vaswani, N. Shazeer, N. Parmar, J. Uszkoreit, L. Jones, A. N. Gomez, Ł. Kaiser, and I. Polosukhin, “Attention is all you need,” Advances in Neural Information Processing Systems, vol. 30, 2017.
[33] J. Devlin, M.-W. Chang, K. Lee, and K. Toutanova, “BERT: Pre-training of deep bidirectional transformers for language understanding,” arXiv preprint arXiv: 1810.04805, 2018.
[34] A. Dosovitskiy, L. Beyer, A. Kolesnikov, D. Weissenborn, X. Zhai, T. Unterthiner, M. Dehghani, M. Minderer, G. Heigold, S. Gelly et al., “An image is worth 16×16 words: Transformers for image recognition at scale,” in International Conference on Learning Representations, 2021.
[35] Z. Liu, Y. Lin, Y. Cao, H. Hu, Y. Wei, Z. Zhang, S. Lin, and B. Guo, “Swin transformer: Hierarchical vision transformer using shifted windows,” in Proceedings of the IEEE/CVF International Conference on Computer Vision, 2021, pp. 10012-10022.
[36] X. Dong, J. Bao, D. Chen, W. Zhang, N. Yu, L. Yuan, D. Chen, and B. Guo, “Cswin transformer: A general vision transformer backbone with cross-shaped windows,” in Proceedings of the IEEE/CVF Conference on Computer Vision and Pattern Recognition, 2022, pp. 12124-12134.
[37] H. Chen, Y. Wang, T. Guo, C. Xu, Y. Deng, Z. Liu, S. Ma, C. Xu, C. Xu, and W. Gao, “Pre-trained image processing transformer,” in Proceedings of the IEEE/CVF Conference on Computer Vision and Pattern Recognition, 2021, pp. 12299-12310.
[38] J. Liang, J. Cao, G. Sun, K. Zhang, L. Van Gool, and R. Timofte, “SwinIR: Image restoration using swin transformer,” in Proceedings of the IEEE/CVF International Conference on Computer Vision, 2021, pp. 1833-1844.
[39] Z. Wang, X. Cun, J. Bao, W. Zhou, J. Liu, and H. Li, “Uformer: A general u-shaped transformer for image restoration,” in Proceedings of the IEEE/CVF Conference on Computer Vision and Pattern Recognition, 2022, pp. 17683-17693.
[40] S. W. Zamir, A. Arora, S. Khan, M. Hayat, F. S. Khan, and M.-H. Yang, “Restormer: Efficient transformer for high-resolution image restoration,” in Proceedings of the IEEE/CVF Conference on Computer Vision and Pattern Recognition, 2022, pp. 5728-5739.
[41] Z. Chen, Y. Zhang, J. Gu, L. Kong, X. Yuan et al., “Cross aggregation transformer for image restoration,” Advances in Neural Information Processing Systems, vol. 35, pp. 25478-25490, 2022.
[42] J. Zhang, Y. Zhang, J. Gu, Y. Zhang, L. Kong, and X. Yuan, “Accurate image restoration with attention retractable transformer,” in International Conference on Learning Representations, 2023.
[43] D. Ye, Z. Ni, W. Yang, H. Wang, S. Wang, and S. Kwong, “Glow in the dark: Low-light image enhancement with external memory,” IEEE Transactions on Multimedia, pp. 1-16, 2023.
[44] D. Ye, Z. Ni, H. Wang, J. Zhang, S. Wang, and S. Kwong, “Csformer: Bridging convolution and transformer for compressive sensing,” IEEE Transactions on Image Processing, vol. 32, pp. 2827-2842, 2023.
[45] Z. Pan, J. Cai, and B. Zhuang, “Fast vision transformers with hilo attention,” Advances in Neural Information Processing Systems, 2022.
[46] K. Yuan, S. Guo, Z. Liu, A. Zhou, F. Yu, and W. Wu, “Incorporating convolution designs into visual transformers,” in Proceedings of the IEEE/CVF International Conference on Computer Vision, 2021, pp. 579-588.
[47] K. B. Krishnan, S. P. Ranga, and N. Guptha, “A survey on different edge detection techniques for image segmentation,” Indian J. Sci. Technol, vol. 10, no. 4, pp. 1-8, 2017.
[48] P. A. Mlsna and J. J. Rodriguez, “Gradient and laplacian edge detection,” in The Essential Guide to Image Processing. Elsevier, 2009, pp. 495-524.
[49] A. S. Ahmed, “Comparative study among sobel, prewitt and canny edge detection operators used in image processing,” J. Theor. Appl. Inf. Technol, vol. 96, no. 19, pp. 6517-6525, 2018.
[50] S. R. Gunn, “On the discrete representation of the laplacian of gaussian,” Pattern Recognition, vol. 32, no. 8, pp. 1463-1472, 1999.
[51] F. Chollet, “Xception: Deep learning with depthwise separable convolutions,” in Proceedings of the IEEE/CVF Conference on Computer Vision and Pattern Recognition, 2017, pp. 1800-1807.
[52] D. P. Kingma and J. Ba, “Adam: A method for stochastic optimization,” arXiv preprint arXiv: 1412.6980, 2014.
[53] Z. Wang, A. C. Bovik, H. R. Sheikh, and E. P. Simoncelli, “Image quality assessment: from error visibility to structural similarity,” IEEE Transactions on Image Processing, vol. 13, no. 4, pp. 600-612, 2004.

1. A computer-implemented method for restoring a compressed image with raindrops, comprising:
applying dual branches in a complementary manner for capturing low-frequency features and high-frequency features from the compressed image;
extracting the high-frequency features by a high-frequency depth-wise convolution (HFDC) with zero-mean kernels; and
fusing the low-frequency features and the high-frequency features by a low-high-attention module (LHAM) by adaptively allocating the importance of the branches among channels.

2. The computer-implemented method of claim 1, wherein the low-frequency features comprise global contextual information under raindrops, and the high-frequency features comprise local high-frequency details which can be lost due to compression.

3. The computer-implemented method of claim 1, wherein the dual branches comprise a low-frequency branch to extract the low-frequency features by a self-attention mechanism, and a high-frequency branch to extract the high-frequency features by the HFDC.

4. The computer-implemented method of claim 3, wherein the self-attention mechanism comprises a relative position multi-head self-attention (RMSA).

5. The computer-implemented method of claim 1, wherein extracting the high-frequency features by the HFDC comprises:
splitting an input of the HFDC into multiple channels;
applying a high-frequency convolution (HFConv) on each channel; and
concatenating features from each channel.

6. The computer-implemented method of claim 5, wherein applying the HFConv on each channel comprises removing a spatial mean from initial kernels and applying the resulted kernels on convolution.

7. The computer-implemented method of claim 1, wherein the high-frequency branch comprises a reshaping/flattening operation, the HFDC, and a 1×1 point-wise convolution (PConv).

8. The computer-implemented method of claim 1, wherein the LHAM is a window-wise attention scheme, which is performed in each local window.

9. The computer-implemented method of claim 8, wherein the process in the local window comprises:
mixing the low-frequency features and the high-frequency features from the two branches to obtain integrated features, and reshaping the integrated features into spatial features which are further fed to a ReLU layer to obtain mixed features;
aggregating the mixed features to obtain compact features by applying average pooling on each channel;
obtaining weight matrices for the low-frequency features and the high-frequency features from the compact features; and
generating weighted low-frequency and high-frequency features by performing a channel-wise addition on the low-frequency and the high-frequency features and their corresponding weight matrices, and generating fused features by performing an element-wise addition.

10. The computer-implemented method of claim 9, wherein in generating the fused features, different channels of the fused features are configured as different combinations of low-frequency and high-frequency features.

11. The computer-implemented method of claim 1, further comprising:
merging the fused features to full-resolution features; and
adding the full-resolution features to input features of the compressed image.

12. The computer-implemented method of claim 11, further comprising:
applying a locally-enhanced feed-forward network (LeFF) on the features to produce output features.

13. The computer-implemented method of claim 12, wherein the LeFF is configured to perform dimensional operations and non-linear processing on the features.

14. The computer-implemented method of claim 1, wherein applying the dual branches is performed in a framework level, extracting the high-frequency features by the HFDC is performed in a component level, and fusing the low-frequency features and the high-frequency features by the LHAM is performed in a module level.

15. A low-high frequency transformer (LHFT) module configured to perform the computer-implemented method of claim 1, comprising:
a self-attention mechanism for extracting low-frequency features from a compressed image;
a high-frequency depth-wise convolution (HFDC) with zero-mean kernels for extracting high-frequency features; and
a low-high-attention module (LHAM) for fusing the low-frequency features and the high-frequency features.

16. A hierarchical U-shaped encoder-decoder network with residual learning for restoring a compressed image with raindrops, comprising:
an input projection block to extract features from an input image;
an encoder block to extract multi-scale features, the encoder block including two or more encoder sub-blocks and a bottleneck block, wherein each encoder sub-block comprises a sequential stacking of low-high frequency transformer (LHFT) modules and a down-sampling layer to reduce spatial resolution and expand channel dimension of the features;
a decoder block to restore features, the decoder block including two or more decoder sub-blocks corresponding to two or more spatial resolutions, wherein each decoder sub-block comprises an up-sampling layer to double the spatial resolution and reduce half of the channel, and a concatenation unit to concatenate the up-sampled features and the features from the corresponding encoder sub-block by skip-connection, and a sequential stacking of LHFT modules;
an output projection block to reconstruct a residual image based on the restored features; and
an addition unit to obtain a reconstructed image by adding the residual image and the input image,
wherein the LHFT modules include the LHFT of claim 1.

17. A system for restoring a compressed image with raindrops, comprising:
one or more processors; and
a memory storing one or more programs configured to be executed by the one or more processors, the one or more programs including instructions for performing or facilitating performing of the computer-implemented method of claim 1.

18. A non-transitory computer readable medium having instructions stored thereon which, when executed by one or more processors, cause the one or more processors to execute the computer-implemented method of claim 1.
